(19) United States
(12) Patent Application Publication
(10) Pub. No.: US 2019/0282928 A1
(43) Pub. Date: Sep. 19, 2019

(54) EXTRACTION PROCESS SPLASH GUARD AND DIFFUSER

(71) Applicant: Waters Technologies Corporation, Milford, MA (US)

(72) Inventors: Edward J. Ognibene, Belmont, MA (US); Michael Webster, Gibsonia, PA (US); Pratik Gandhi, Mars, PA (US); Steven Stricko, Trafford, PA (US); Darcy Shave, Blackstone, MA (US); Andrew Aubin, Taunton, MA (US); Joseph D. Antocci, Leominster, MA (US); Richard Skinner, Mendon, MA (US); Bryan Cumming, Lunenburg, MA (US); Ziqiang Wang, Lansdale, PA (US)

(73) Assignee: Waters Technologies Corporation, Milford, MA (US)

(21) Appl. No.: 16/351,748

(22) Filed: Mar. 13, 2019

Related U.S. Application Data
(60) Provisional application No. 62/643,671, filed on Mar. 15, 2018.

(51) Int. Cl. B01D 17/02; B01D 11/04

(52) U.S. Cl. CPC B01D 17/0217; B01D 11/0403

(57) ABSTRACT

The present disclosure relates to methodologies, systems, and devices for collecting extract in a CO₂-based extraction system. A diffuser can be used, attached to one end of an extraction tube, in order to depressurize the CO₂ and extract mixture as it exits the diffuser and enters the extraction collection container. A splash guard can also be attached to the extraction tube in order to block any splashing of extract while CO₂ is allowed to vent from the extraction collection container.

### RELATED APPLICATION

This application claims priority from and the benefit of U.S. Provisional Patent Application No. 62/643,671 filed on Mar. 15, 2018 and titled EXTRACTION PROCESS SPLASH GUARD AND DIFFUSER, the entire contents of which are incorporated herein by reference.

### FIELD OF THE TECHNOLOGY

The present disclosure generally relates to carbon dioxide (CO₂) based extraction systems. In particular, the present disclosure relates to a splash guard and diffuser for use in a CO₂ based extraction system.

### BACKGROUND

CO₂ based extraction systems, such as for example, supercritical fluid extraction (SFE) systems utilizing CO₂ in the extraction fluid, extract chemical compounds using supercritical or near supercritical CO₂ instead of an organic solvent. The supercritical fluid state occurs when a fluid is above its critical temperature and critical pressure, when it is between the typical gas and liquid state. Manipulating the temperature and pressure of the fluid can solubilize the material of interest and selectively extract it. Typically in SFE systems, extracts are collected in a liquid form using a cyclone separator which is periodically tapped by an operator during the extraction process via a valve at the bottom of the cyclone, allowing the fluid to flow freely from the valve. When the collected material is too viscous, or in a solid form, it does not flow freely from a valve and can splash or sputter outside the collection beaker or onto a user.

### SUMMARY

Collecting extracts from CO₂-based extraction systems raises a number of challenges, especially when dealing with a viscous or solid extracts. Technology for collecting viscous or solid extracts in an efficient and clean manner would be beneficial and highly desirable.

In general, certain embodiments of the present technology feature a device configured to prevent or minimize splashing or sputtering from an extraction container. In certain embodiments, this device is positioned at or near a top portion of the container and is configured to rest on the container to provide a flange or a guard to prevent and/or re-direct an extract from being transported or escaping from the extract collection container. In some embodiments, this device includes vents for the release of the extraction fluid (e.g., CO₂). The device may be used in combination with a diffuser, which directs extract and/or extract fluid away from the bottom of the collection container. That is, in some embodiments, the diffuser provides additional protection/minimization of sputtering from the extract collection container by redirecting and/or breaking up the fluid flow such that less extract is forced upward toward the top of the container.

In one aspect, the present technology relates to a guard for an extraction process. The guard includes a body having a cylindrical extension including a passage, and a disc shaped support flange radially extending from the body and having at least one vent hole extending parallel to a central vertical axis and radially offset from the body. The guard also includes an outer baffle and an inner baffle. The outer baffle radially extends from the body and is spaced from the disc shaped support flange along the central vertical axis. The inner baffle extends radially from the body and is spaced from the disc shaped support flange along the central vertical axis. The outer baffle and the inner baffle are disposed on opposing sides of the disc shaped support flange and overlap the vent hole. In a non-limiting example, the passage is configured and dimensioned to receive therein an extraction tube of a cyclone separator. In another non-limiting example, the disc shaped support flange defines a convex configuration. In another non-limiting example, the disc shaped support flange includes a circumferential lip extending perpendicularly relative to the central vertical axis. In another non-limiting example, the disc shaped support flange radially surrounds the outer baffle. In another non-limiting example, at least one of the overlapping outer baffle or inner baffle is centered relative to the vent hole vertical axis.

In another aspect, the present technology relates to a diffuser for an extraction process. The diffuser includes a body including an entrance opening extending from a proximal end of the body along a central vertical axis, and at least one exit opening near a distal end of the body and extending at an angle relative to the central vertical axis, the entrance opening and the at least one exit opening being in fluid communication. The diffuser also includes a skirt connected to the body and surrounding the at least one exit opening of the body. In a non-limiting example, the entrance opening is a blind hole. In another non-limiting example, the entrance opening includes a first section and a second section, a diameter of the first section being dimensioned greater than a diameter of the second section. In another non-limiting example, the first section of the entrance opening extends from the proximal end of the body, and the second section of the entrance opening fluidically connects with the at least one exit opening. In another non-limiting example, the diffuser also includes a radial step between the first section and the second section of the entrance opening, the radial step functioning as a mechanical stop for an extraction tube received in the entrance opening. In another non-limiting example, the angle of the at least one exit opening relative to the central vertical axis is at least 10 degrees. In another non-limiting example, the angle of the at least one exit opening relative to the central vertical axis is 90 degrees. In another non-limiting example, the body comprises an engagement mechanism for engagement with an extraction tube received within the entrance opening. In another non-limiting example, a side wall of the skirt is spaced from the at least one exit opening of the body by a distance of between 1 mm and 10 mm.

In another aspect, the present technology relates to an extraction process system including a guard. The guard includes a body having a cylindrical extension including a passage. The guard also includes a disc shaped support flange radially extending from the body and having at least one vent hole extending parallel to a central vertical axis and radially offset from the body. The guard also includes an outer baffle radially extending from the body and spaced from the disc shaped support flange along the central vertical axis. The guard also includes an inner baffle radially extending from the body and spaced from the disc shaped support flange along the central vertical axis. The outer baffle and the inner baffle are disposed on opposing sides of the disc shaped support flange and overlap the at least one vent hole. The system also includes a diffuser, which includes a body including an entrance opening extending from a proximal end of the body along a central vertical axis, and at least one exit opening near a distal end of the body and extending at an angle relative to the central vertical axis, the entrance opening and the at least one exit opening being in fluid communication. The diffuser also includes a skirt connected to the body and surrounding the at least one exit opening of the body.

The above aspects of the technology provide numerous advantages. For example, systems and methods of the present technology prevent waste and reduce hazards related to splashing of extracts while using CO₂-based extraction systems. In particular, conventional systems do not have the ability to safely vent CO₂ while preventing portions of the extract from exiting an extract collection container. Conventional systems are also not able to create the quick pressure drop generated by the diffuser disclosed herein. As a result, pressure within conventional extract collection containers can result in loss of the extract during extract collection.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

One of ordinary skill in the art will understand that the drawings primarily are for illustrative purposes and are not intended to limit the scope of the inventive subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a perspective view of an example splash guard, according to an embodiment of the present disclosure.

FIG. 2 is a cross sectional view of the example splash guard of FIG. 1, according to an embodiment of the present disclosure.

FIG. 3 is a perspective view of another example splash guard, according to an embodiment of the present disclosure.

FIG. 4 shows an example extraction tube, splash guard, and diffuser, according to an embodiment of the present disclosure.

FIG. 5 is a cross sectional view of an example splash guard, diffuser, and extract collection container, according to an embodiment of the present disclosure.

FIG. 6A is a side view of an example diffuser, according to an embodiment of the present disclosure.

FIG. 6B is a cross sectional view of the diffuser of FIG. 6A, according to an embodiment of the present disclosure.

FIG. 6C is a top-down view of the diffuser of FIG. 6A, according to an embodiment of the present disclosure.

FIG. 7 is a perspective view of an example diffuser, according to an embodiment of the present disclosure.

FIG. 8 is a diagram of an example CO₂-based extraction system suitable for use with the splash guard and diffuser described herein, according to an embodiment of the present disclosure.

The features and advantages of the present disclosure will become more apparent from the detailed description set forth below when taken in conjunction with the drawings.

### DETAILED DESCRIPTION

Following below are more detailed descriptions of various concepts related to, and embodiments of, methodologies, devices, and systems for CO₂-based extraction. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means includes but is not limited to, the term “including” means including but not limited to. The term “based on” means based at least in part on.

During CO₂-based extraction, an extract is separated from CO₂ within an extract collection container, and the separated extract can be removed from the collection container. In some embodiments, a series of pressurized vessels can be used to separate the different components that are being extracted from a matrix. Upon opening the collection container, some pressure may still be present within the container causing splashing or sputtering of CO₂ and the extract. This splashing can be wasteful and potentially dangerous if the user is not wearing protective clothing or goggles. According to embodiments of the present disclosure, a splash guard and diffuser can be used, along with an extraction tube, in order to depressurize the CO₂ and extract mixture as it exits the diffuser and enters the extraction collection container, and to block any splashing of extract while CO₂ is allowed to vent from the extraction collection container.

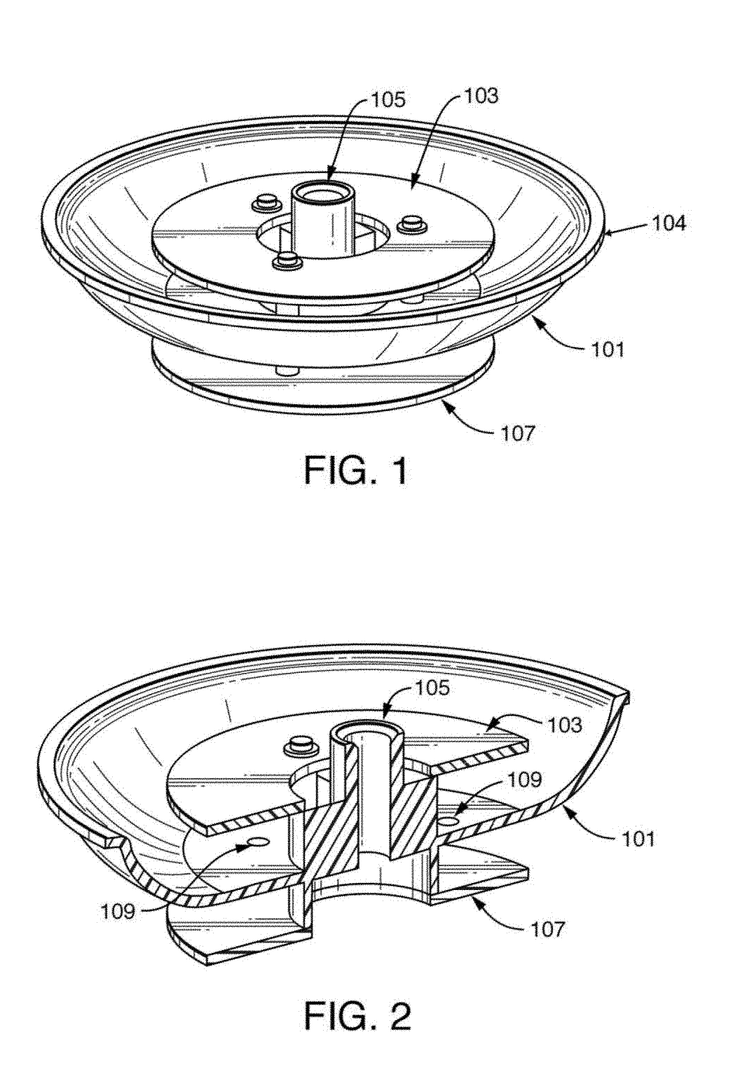

FIG. 1 shows a perspective view of a splash guard, according to an exemplary embodiment of the present disclosure. In some embodiments, the splash guard can be an injection molded assembly that includes four main components: a body with a cylindrical extension 105, a disc shaped support flange 101, an outer baffle 103, and an inner baffle 107. The outer baffle 103 and inner baffle 107 are positioned on opposite sides of the disc shaped support flange 101. As will be appreciated, the splash guard can be formed using other techniques including machining or 3D-printing, among others. The function of the splash guard is to prevent splashing and/or loss of extract when transferring the extract from a cyclone vessel to an extract collection container. In some embodiments, the splash guard can be sized to fit the particular dimensions of an extract collection container. The splash guard can have a substantially circular footprint, in some embodiments, and can be configured to rest on a cylindrical extract collection container. The disc shaped flange 101 can have a concave design, in some examples, which allows it to fit on containers of multiple sizes and diameters. In some embodiments, the disc shaped flange 101 is about 30 cm in diameter. The disc shaped flange 101 may also include a circumferential lip 104 extending perpendicularly relative to the central vertical axis of the splash guard. The various components of the splash guard can be molded, printed, or otherwise formed from, for example, a co-polymer clarified polypropylene but could also be formed of other polymers or plastic resins including, but not limited to: polyethylene, ABS, or a PC-ABS blend. The components can also be machined and then joined using screws or solvent bonding, in some embodiments.

In a non-limiting example, the cylindrical extension 105 defines a bore or passage that passes through the central axis of the splash guard. The passage can be configured to flow a fluid including a mixture of an extract and an extraction fluid by allowing an extraction tube of a cyclone separator to pass through the center of the splash guard. In some embodiments, the splash guard can slide along the length of the extraction tube. In a non-limiting example, the inner baffle 107 and outer baffle 103 can be disc shaped and mounted on or near the cylindrical extension 105. The inner baffle 107 can be mounted to an inner side of the cylindrical extension 105, such that the inner baffle 107 is positioned inside an extract collection container when the splash guard is placed on the container. The outer baffle 103 can extend from or be mounted near an outer side of the cylindrical extension 105, such that the outer baffle 103 is outside the extract collection container when the splash guard is placed on the container. In some embodiments, the outer baffle 103 can fit entirely within the concave portion of the disc shaped flange 101 such that the disc shaped flange 101 radially surrounds the outer baffle 103.

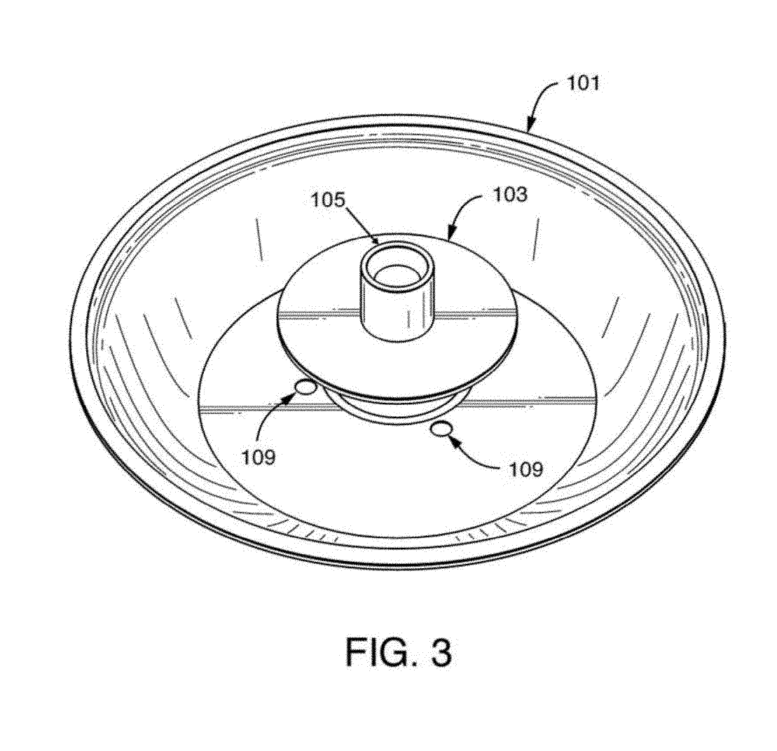

FIG. 2 shows a cross sectional view of the splash guard of FIG. 1, according to an exemplary embodiment of the present disclosure. In some embodiments, the disc shaped flange 101 can include vent holes 109 located in a radial pattern near the cylindrical extension to allow CO₂ gas to escape from an extract collection container. The vent holes 109 can be configured to extend parallel to a central vertical axis of the splash guard, in some embodiments, and may be radially offset from the cylindrical extension 105. In a non-limiting example, the disc shaped flange 101 can also include bosses configured to accept screws for attaching the inner baffle 107 and the outer baffle 103. In a non-limiting example, the outer baffle 103 can be mounted approximately 1.27 cm (0.50 inches) from the base of the concave surface of the disc shaped flange 101, and the inner baffle 107 can be mounted approximately 1.27 cm (0.50 inches) from the convex surface of the disc shaped flange 101. Each of the inner baffle 107 and the outer baffle 103 can be configured to overlap the vent holes 109 such that they block any direct splashing or spattering of the extract from the extract collection container, while allowing gas to safely escape the extract collection container.

FIG. 3 shows a perspective view of another example splash guard, according to an exemplary embodiment of the present disclosure. In this non-limiting example, the outer baffle 103 extends from the cylindrical extension 105 and is configured to vertically cover the vent holes 109 in the disc shaped flange 101. By having the outer baffle 103 vertically cover the vent holes 109, the outer baffle 103 can act as a barrier blocking any extract that may splash through the vent holes 109 from exiting the system.

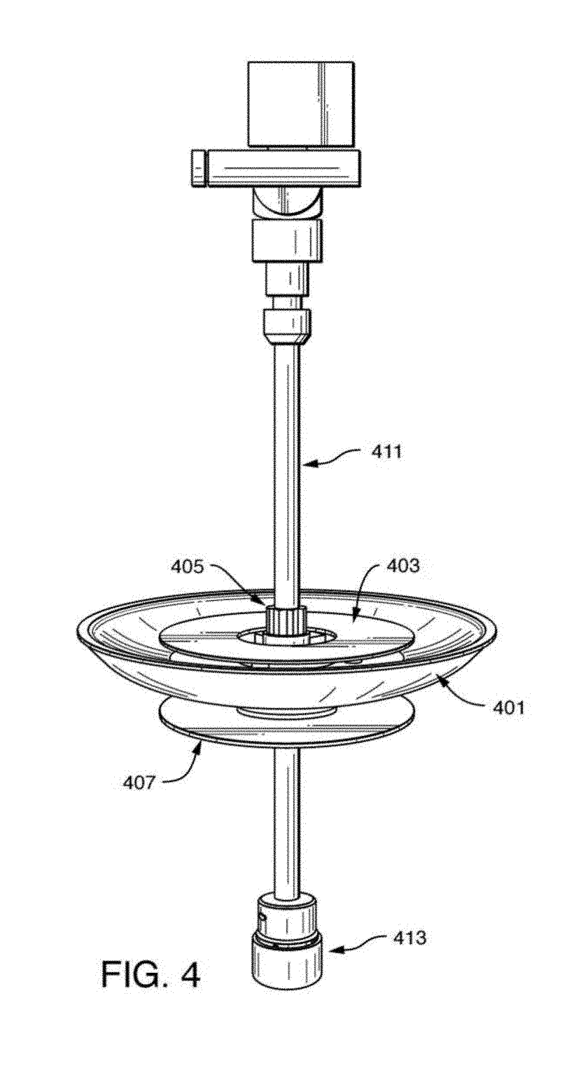

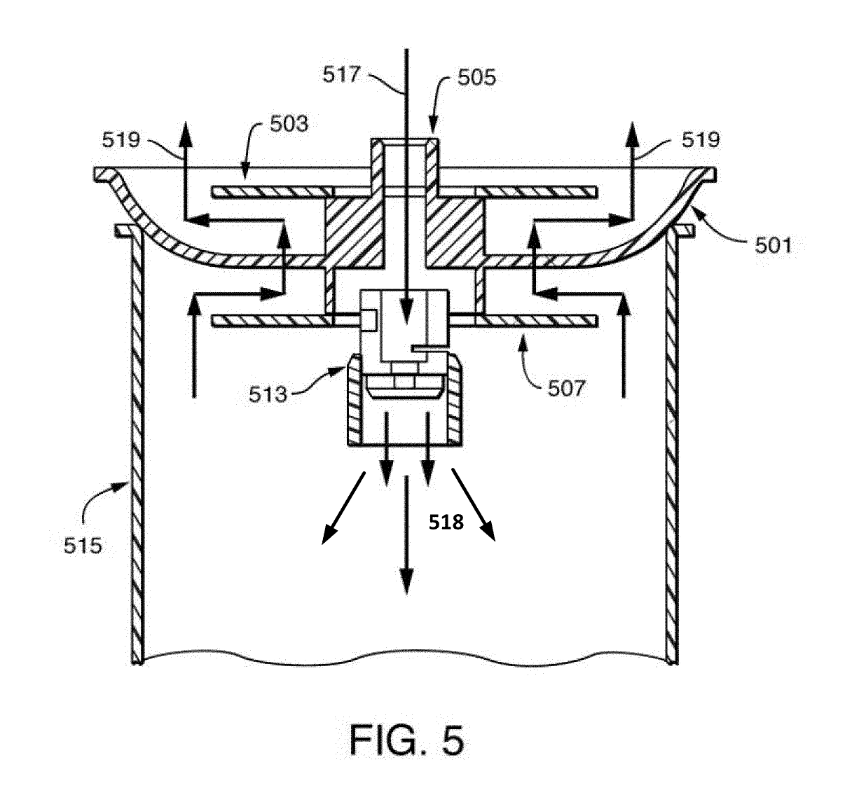

FIG. 4 shows an example splash guard mounted on an extraction tube 411 with a diffuser 413, according to an exemplary embodiment of the present disclosure. In this non-limiting example, the splash guard includes a cylindrical extension 405, a disc shaped flange 401, an inner baffle 407, and an outer baffle 403. The cylindrical extension 405 defines a passage, in this example embodiment, through which the extraction tube 411 can pass. In a non-limiting example, the extraction tube 411 carries extract from an extraction vessel to an extract collection container. An example CO₂-based extraction system is described in more detail below with reference to FIG. 8. The splash guard can be configured to slide freely along the extraction tube 411, in some embodiments. The diffuser 413 can be located at or near the end of the extraction tube 411, in some embodiments, and can be configured to diffuse a fluid flow from the extraction tube 411. That is, the diffuser 413 breaks up or disrupts the fluid flow from a unitary or single stream into numerous flow streams. The diffuser and its operation are discussed in more detail below in reference to FIGS. 5-7.

FIG. 5 is a cross sectional view of an example splash guard with a diffuser 513 positioned inside an extract collection container 515, according to an embodiment of the present disclosure. This particular embodiment shows the splash guard positioned on an extract collection container 515 with a diffuser 513 inside the container 515; however, the present disclosure is not limited to embodiments utilizing both a splash guard and a diffuser. For example, in some embodiments, the splash guard can be used without the diffuser 513 described herein. The example splash guard can include a body with a cylindrical extension 505, a disc shaped support flange 501 that is configured to rest on the extract collection container 515, an outer baffle 503, and an inner baffle 507 that is positioned inside the extract collection container 515. As discussed above, the splash guard is configured to slide along the length of an extraction tube (not shown) such that the disc shaped support flange 501 rests on the upper edge or rim of the cylindrical extract collection container 515, in some embodiments. In some embodiments, the splash guard is not mechanically constrained or secured to the extract collection container 515, and the disc shaped support flange 501 rests on the rim of the container 515 and can rotate radially or be lifted from the rim of the container 515 if pressure within the container 515 is sufficiently high. In a non-limiting example, a fluid flow 517 passes through an extraction tube (not shown) and enters the diffuser 513. Within the diffuser 513, the fluid flow 517 is broken up into numerous flow streams 518 as it exits the diffuser 513 and enters the extract collection container 515. By breaking up the fluid flow 517 from the extraction tube into numerous flow streams 518, the diffuser 513 controls the fluid flow into the container such that it does not directly hit the bottom of the container as a single stream. Instead, the flow streams 518 can be directed or angled in numerous directions in order to prevent direct splashing from the bottom of the extract collection container 515. Within the extract collection container 515, the extract is collected and CO₂ is allowed to escape from the extract collection container 515 through vent holes (as shown in FIGS. 2 and 3) in the disc shaped support flange 501. The inner baffle 507 and the outer baffle 503 are configured to block any splashing or sputtering of the extract as the CO₂ exits the extract collection container 515 because the baffles 507, 503 are configured to cover the vent holes in the disc shaped support flange 501. In a non-limiting example, any extract that is able to splash out of the extract collection container 515 through the vent holes may be blocked by the outer baffle 503 and can fall back within the concave portion of the disc shaped support flange 501 and back into the extract collection container 515.

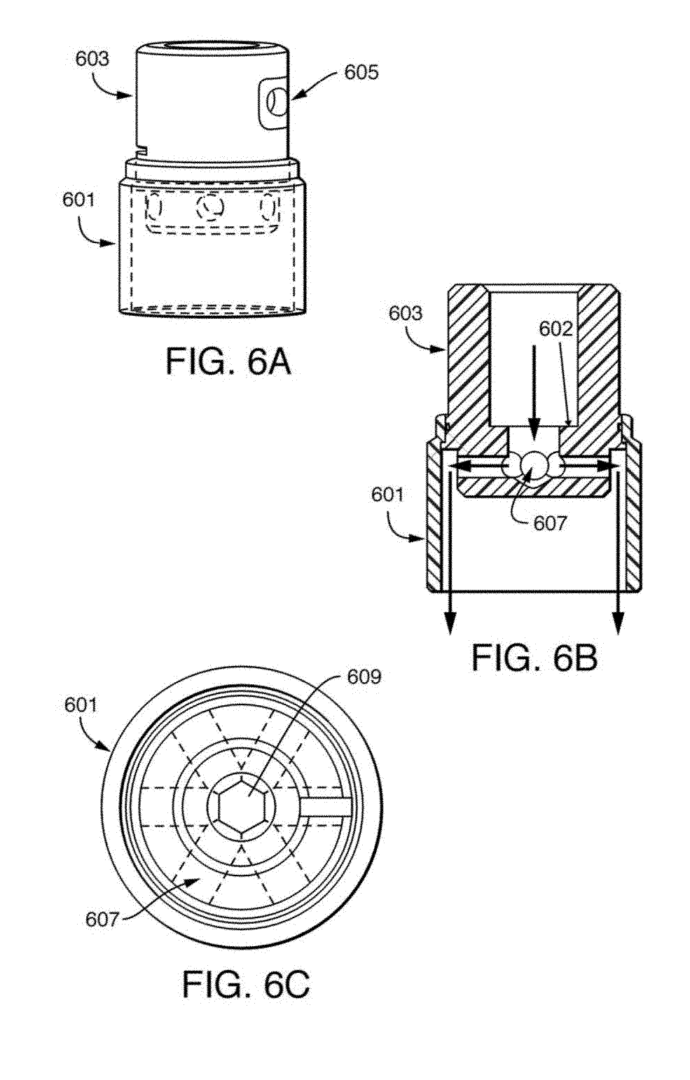

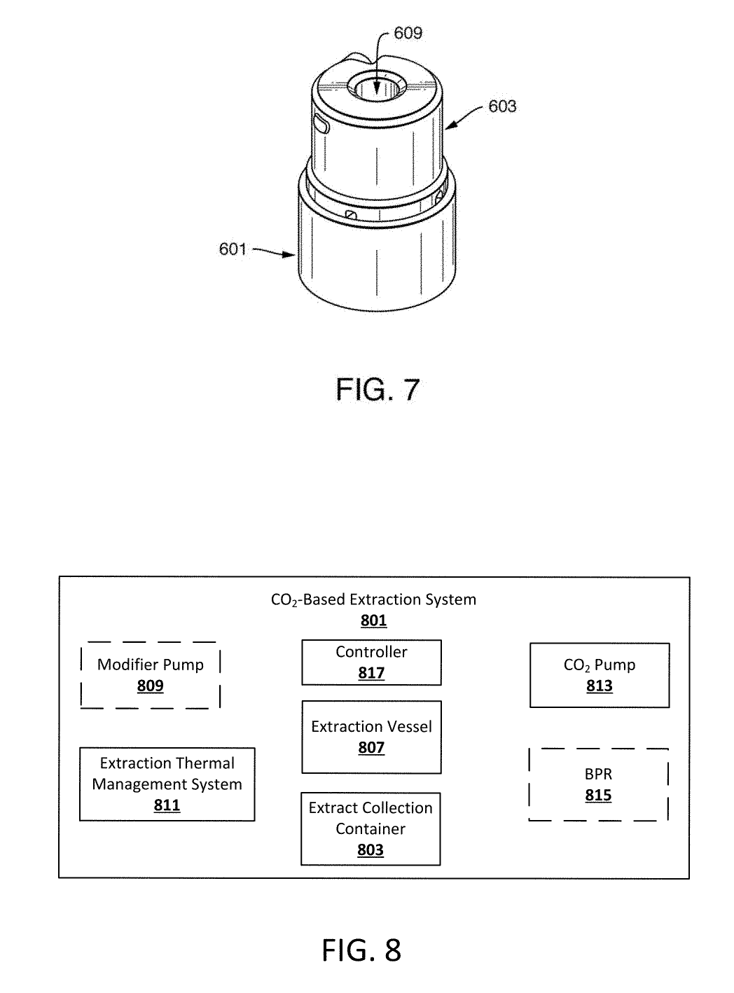

FIGS. 6A-6C show various views of an example diffuser, according to an embodiment of the present disclosure. FIG. 6A is a side view of an example diffuser that includes a diffuser body 603 and a diffuser skirt 601. FIG. 6B is a cross sectional view of the diffuser of FIG. 6A, and FIG. 6C is a top-down view of the diffuser of FIG. 6A. FIG. 7 is a perspective view of the example diffuser from FIG. 6A, according to an embodiment of the present disclosure.

In a non-limiting example, the diffuser body 603 defines a clamp feature 605 that can be used to attach the diffuser to an extraction tube. In some embodiments, the diffuser body 603 includes an entrance opening 609 extending from one end of the diffuser body 603 along a central axis, within which an extraction tube can be inserted. In a non-limiting example, the entrance opening 609 is a blind hole that is in fluid communication with at least one radially extending channel 607. Within the entrance opening 609, a radial step 602 functions as a mechanical stop for the extraction tube. The radial step 602 can define a second section of the entrance opening 609 having a smaller diameter than the first section of the entrance opening 609. The diffuser body also includes at least one exit opening or channel 607 in fluid communication with the entrance opening 609. The one or more channels 607 can be in fluid communication with the second section of the entrance opening 609, in some embodiments. As can be seen in this example embodiment, the diffuser body 603 is coupled to the diffuser skirt 601 such that the one or more channels 607 can guide a fluid flow from the extraction tube, through the entrance opening 609, and into the interior of the diffuser skirt via the exit openings or channels 607. In the example embodiment shown in FIGS. 6A-6C, the diffuser body 603 has six radially extending exit openings or channels 607.

In a non-limiting example, the diffuser can be located at or near the end of the extraction tube and attached to the extraction tube using the clamp collar feature 605 shown in FIG. 6A. In some embodiments, the diffuser body 603 and diffuser skirt 601 can help control the mixture of extract and CO₂ exiting the extraction tube in order to prevent the mixture from directly hitting the bottom of the extract collection container and splash or spatter. Excess slashing of the mixture exiting the diffuser skirt 601 can cause both loss of product and unwanted messes, in some cases. The diffuser can include, in some embodiments, two components that may be fixed or mechanically staked together. That is, the two components, in some embodiments, can be inseparable or unitarily formed. This feature may be important for controlling and directing fluid flow in a system where CO₂ is experiencing a phase change. In a non-limiting example, the diffuser components can include a diffuser body 603 and a diffuser skirt 601 that can be machined or otherwise formed from stainless steel (such as, for example, 316 stainless steel). The diffuser body 603 can be cylindrical in design and can include a clamp collar feature 605 for attaching the diffuser to the extraction tube. In a non-limiting example, the diffuser body 603 also includes a central bore or entrance opening 609 that goes through a portion of the central axis of the diffuser, but does not go all the way through the diffuser body 603. A mechanical stop or radial step 602 can be formed on the interior wall of the entrance opening 609 in order to prevent the extraction tube from passing all the way through the entrance opening and being closed off by the bottom interior of the diffuser body 603. In a non-limiting example, at or near the bottom of the entrance opening 609 of the diffuser body 603, a number of radial holes or channels 607 extend outward and access the exterior sides of the cylindrical diffuser body 603. These radial holes or channels 607 can direct the extract fluid at between about a 10-90 degree angle from its initial path through the extraction tube. In some embodiments, the angle of at least one of the channels 607 relative to the central vertical axis of the diffuser body 603 is about 90 degrees.

The diffuser skirt 601 can be cylindrical in design and can be mechanically fastened to the diffuser body 603, in some embodiments. In a non-limiting example, a substantially hollow cylindrical diffuser skirt has an internal diameter that is greater than the outer diameter of the diffuser body 603, such that the internal surface at one end of the diffuser skirt 601 can be fastened to an outer portion of the diffuser body 603. The diffuser skirt 601 can be fastened to an outer portion of the diffuser body 603 upstream of the radial holes or channels 607 of the diffuser body 603, such that the mixture of extract and CO₂ exiting the channels 607 enters the interior of the hollow cylindrical diffuser skirt 601. The diffuser body 603 and the diffuser skirt 601 can be coupled or fastened such that there is a gap between the exit of the channels 607 in the diffuser body 603 and the inner surface of the diffuser skirt 601. In such an embodiment, the extract fluid flowing through the channels 607 can be directed against the interior side walls of the diffuser skirt 601, into the space between the diffuser body 603 and the diffuser skirt 601. The extract fluid can then fall downward and out of the open end of the diffuser skirt 601 and into an extract collection container, as shown in FIG. 5. In a non-limiting example, the interior side wall of the diffuser skirt 601 is spaced from the exit of the channels 607 by a distance of between 1.0 mm and 10 mm. In some embodiments, the diffuser skirt 601 extends along the axis of the diffuser at least 1 cm beyond the channels 607.

The winding and torturous extract fluid path through the diffuser body 603 and the diffuser skirt 601 allows a pressure drop in the mixture of extract and CO₂, in some embodiments. Such a path also slows the extract fluid velocity, resulting in less splashing or spattering of the extract mix within the collection container. Further, by breaking up or diffusing the extract fluid flow, the splashing effect within the collection container is reduced by reducing direct vertical splashing of the fluid flow against the bottom of the collection container.

FIG. 8 is a diagram of an example CO₂-based extraction system 801 suitable for use with the splash guard and diffuser described herein, according to an embodiment of the present disclosure. The CO₂-based extraction system 801 can include, for example, a modifier pump 809 (optional), a controller 817, a CO₂ pump 813, an extraction thermal management system 811, an extraction vessel 807, an extract collection container 803 that can include the splash guard and diffuser described herein, and possibly a BPR 815 (optional). Such an extraction system can provide safe and efficient CO₂-based extraction by preventing splashing from the extract collection container 803 using the splash guard and diffuser described herein.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes a plurality of system elements, device components or method steps, those elements, components or steps can be replaced with a single element, component or step. Likewise, a single element, component or step can be replaced with a plurality of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the disclosure. Further still, other aspects, functions and advantages are also within the scope of the disclosure.

In describing certain examples, specific terminology is used for the sake of clarity. For purposes of description, each specific term is intended to at least include all technical and functional equivalents that operate in a similar manner to accomplish a similar purpose. Additionally, in some instances where a particular example embodiment includes a plurality of system elements, device components or method steps, those elements, components or steps may be replaced with a single element, component or step. Likewise, a single element, component or step may be replaced with a plurality of elements, components or steps that serve the same purpose. Moreover, while example embodiments have been shown and described with references to particular embodiments thereof, those of ordinary skill in the art will understand that various substitutions and alterations in form and detail may be made therein without departing from the scope of the invention. Further still, other aspects, functions and advantages are also within the scope of the disclosure.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be examples and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that inventive embodiments may be practiced otherwise than as specifically described. Inventive embodiments of the present disclosure are directed to each individual feature, system, article, material, kit, and/or method described herein. In addition, any combination of two or more such features, systems, articles, materials, kits, and/or methodologies, if such features, systems, articles, materials, kits, and/or methodologies are not mutually inconsistent, is included within the inventive scope of the present disclosure.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A guard for an extraction process, comprising:
a body having a cylindrical extension including a passage for flowing a fluid including a mix of an extract and extraction fluid;
a disc shaped support flange radially extending from the body and having at least one vent hole extending parallel to a central vertical axis and radially offset from the body;
an outer baffle radially extending from the body and spaced from the disc shaped support flange along the central vertical axis; and
an inner baffle radially extending from the body and spaced from the disc shaped support flange along the central vertical axis,
wherein the outer baffle and the inner baffle are disposed on opposing sides of the disc shaped support flange and overlap the at least one vent hole.

2. The guard of claim 1, wherein the passage is configured and dimensioned to receive therein an extraction tube of a cyclone separator.

3. The guard of claim 1, wherein the disc shaped support flange defines a convex configuration.

4. The guard of claim 1, wherein the disc shaped support flange includes a circumferential lip extending perpendicularly relative to the central vertical axis.

5. The guard of claim 1, wherein the disc shaped support flange radially surrounds the outer baffle.

6. The guard of claim 1, wherein at least one of the overlapping outer baffle or inner baffle is centered relative to the vent hole vertical axis.

7. A diffuser for an extraction process, comprising:
a body including an entrance opening extending from a proximal end of the body along a central vertical axis, and at least one exit opening near a distal end of the body and extending at an angle relative to the central vertical axis, the entrance opening and the at least one exit opening being in fluid communication; and
a skirt connected to the body and surrounding the at least one exit opening of the body.

8. The diffuser of claim 7, wherein the entrance opening is a blind hole.

9. The diffuser of claim 7, wherein the entrance opening includes a first section and a second section, a diameter of the first section being dimensioned greater than a diameter of the second section.

10. The diffuser of claim 8, wherein the first section of the entrance opening extends from the proximal end of the body, and the second section of the entrance opening fluidically connects with the at least one exit opening.

11. The diffuser of claim 10, comprising a radial step between the first section and the second section of the entrance opening, the radial step functioning as a mechanical stop for an extraction tube received in the entrance opening.

12. The diffuser of claim 7, wherein the angle of the at least one exit opening relative to the central vertical axis is at least 10 degrees.

13. The diffuser of claim 12, wherein the angle of the at least one exit opening relative to the central vertical axis is 90 degrees.

14. The diffuser of claim 7, wherein the body comprises an engagement mechanism for engagement with an extraction tube received within the entrance opening.

15. The diffuser of claim 7, wherein a side wall of the skirt is spaced from the at least one exit opening of the body by a distance of between 1 mm and 10 mm.

16. An extraction process system, comprising:
a guard including:
a body having a cylindrical extension including a passage;
a disc shaped support flange radially extending from the body and having at least one vent hole extending parallel to a central vertical axis and radially offset from the body;
an outer baffle radially extending from the body and spaced from the disc shaped support flange along the central vertical axis; and
an inner baffle radially extending from the body and spaced from the disc shaped support flange along the central vertical axis,
wherein the outer baffle and the inner baffle are disposed on opposing sides of the disc shaped support flange and overlap the at least one vent hole; and
a diffuser including:
a body including an entrance opening extending from a proximal end of the body along a central vertical axis, and at least one exit opening near a distal end of the body and extending at an angle relative to the central vertical axis, the entrance opening and the at least one exit opening being in fluid communication; and
a skirt connected to the body and surrounding the at least one exit opening of the body.

17. A method of collecting extraction products from a cyclone separator, comprising flowing an extraction stream through an extraction tube including a guard and a diffuser as recited in claim 16.
